(19) United States
(12) Patent Application Publication
(10) Pub. No.: US 2023/0043820 A1
(43) Pub. Date: Feb. 9, 2023

(54) METHOD AND SYSTEM FOR USER GROUP DETERMINATION, CHURN IDENTIFICATION AND CONTENT SELECTION

(71) Applicant: Verizon Media Inc., New York, NY (US)

(72) Inventors: Rahul Chandran, Champaign, IL (US); Allie Khalil Watfa, Champaign, IL (US); Sergiu Cristian Vlas, Newburgh, IN (US); Osman Erman Gungor, Champaign, IL (US); Gowtham Ayna Raveendran, Champaign, IL (US); Ryan Muraglia, Dexter, MI (US)

(21) Appl. No.: 17/393,448

(22) Filed: Aug. 4, 2021

(51) Int. Cl. G06Q 30/02; G06F 16/28

(52) U.S. Cl. CPC G06Q 30/0201; G06F 16/285; G06Q 30/0255

(57) ABSTRACT

One or more computing devices, systems, and/or methods are provided. In an example, purchase data associated with users may be determined. The purchase data may be indicative of purchases by users from entities. The purchase data may be analyzed to determine purchase metrics associated with the users. The purchase metrics may be analyzed to determine sets of groups of users associated with the entities. One or more groups of users, of the sets of groups of users, that include the user may be determined. Content may be selected for presentation via a first device associated with the first user based upon the one or more groups of users.

### BACKGROUND

Many services, such as websites, applications, etc. may provide platforms for viewing media. For example, a user may interact with a service. While interacting with the service, selected media may be presented to the user automatically. Some of the media may be advertisements advertising products and/or services associated with a company.

### SUMMARY

In accordance with the present disclosure, one or more computing devices and/or methods are provided. In an example, purchase data may be determined. The purchase data may comprise first purchase data indicative of purchases by a first user from first entities and second purchase data indicative of purchases by a second user from second entities. The purchase data may be analyzed to determine a first set of purchase metrics associated with the first user and a second set of purchase metrics associated with the second user. Purchase metrics, comprising the first set of purchase metrics and the second set of purchase metrics, may be analyzed to determine a first set of groups of users associated with a first entity based upon first purchase metrics, of the purchase metrics, associated with the first entity. The purchase metrics may be analyzed to determine a second set of groups of users associated with a second entity based upon second purchase metrics, of the purchase metrics, associated with the second entity. Customer churn of the first user from the first entity to the second entity may be identified based upon a determination that the first user is in an inactive group of users of the first set of groups of users and an active group of users of the second set of groups of users. Content may be selected for presentation via a first device associated with the first user based upon the identification of the customer churn of the first user from the first entity to the second entity.

In an example, purchase data may be determined. The purchase data may comprise first purchase data indicative of purchases by a first user from first entities and second purchase data indicative of purchases by a second user from second entities. The purchase data may be analyzed to determine a first set of purchase metrics associated with the first user and a second set of purchase metrics associated with the second user. The first set of purchase metrics comprises first recency metrics, first frequency metrics and first monetary metrics. The second set of purchase metrics comprises second recency metrics, second frequency metrics and second monetary metrics. Purchase metrics, comprising the first set of purchase metrics and the second set of purchase metrics, may be analyzed to determine sets of groups of users associated with entities comprising a first entity and a second entity. The sets of groups of users comprises a first set of groups of users associated with the first entity, wherein the first set of groups of users is based upon first purchase metrics, of the purchase metrics, associated with the first entity. The sets of groups of users comprises a second set of groups of users associated with the second entity, wherein the second set of groups of users is based upon second purchase metrics, of the purchase metrics, associated with the second entity. One or more first groups of users, of the sets of groups of users, comprising the first user may be determined. Content may be selected for presentation via a first device associated with the first user based upon the one or more first groups of users.

In an example, activity data may be determined. The activity data may comprise first activity data indicative of user activity of a first user with internet resources associated with first entities and second activity data indicative of user activity of a second user with internet resources associated with second entities. The activity data may be analyzed to determine a first set of activity metrics associated with the first user and a second set of activity metrics associated with the second user. Activity metrics, comprising the first set of activity metrics and the second set of activity metrics, may be analyzed to determine a first set of groups of users associated with a first entity based upon first activity metrics, of the activity metrics, associated with the first entity. The activity metrics may be analyzed to determine a second set of groups of users associated with a second entity based upon second activity metrics, of the activity metrics, associated with the second entity. User churn of the first user from the first entity to the second entity may be identified based upon a determination that the first user is in an inactive group of users of the first set of groups of users and an active group of users of the second set of groups of users. Content may be selected for presentation via a first device associated with the first user based upon the identification of the user churn of the first user from the first entity to the second entity.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4A is a flow chart illustrating an example method for identifying customer churn and/or selecting content for presentation via a device based upon the identification of customer churn.

FIG. 4B is a flow chart illustrating an example method for clustering users into groups of users and/or selecting content for presentation via a device based upon the groups of users.

FIG. 5A is a diagram illustrating an exemplary system for clustering users into groups of users and/or selecting content for presentation via a device based upon the groups of users, where purchase data is determined using a purchase data determiner.

FIG. 5B is a diagram illustrating an exemplary system for clustering users into groups of users and/or selecting content for presentation via a device based upon the groups of users, where a plurality of sets of purchase metrics are determined.

FIG. 5C is a diagram illustrating an exemplary system for clustering users into groups of users and/or selecting content for presentation via a device based upon the groups of users, where users are grouped into a plurality of sets of groups of users.

FIG. 5D is a diagram illustrating a chart representative of quantities of users of groups of users for three entities, of an exemplary system for clustering users into groups of users and/or selecting content for presentation via a device based upon the groups of users.

FIG. 5E is a diagram illustrating an exemplary system for clustering users into groups of users and/or selecting content for presentation via a device based upon the groups of users, where a request for content is received by a server associated with a content system.

FIG. 5F is a diagram illustrating an exemplary system for clustering users into groups of users and/or selecting content for presentation via a device based upon the groups of users, where a first content item is presented via a first device.

FIG. 5G is a diagram illustrating an exemplary system for clustering users into groups of users and/or selecting content for presentation via a device based upon the groups of users, where a targeting interface is displayed via a second device associated with a first entity.

FIG. 6 is a flow chart illustrating an example method for identifying user churn and/or selecting content for presentation via a device based upon the identification of user churn.

FIG. 7 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

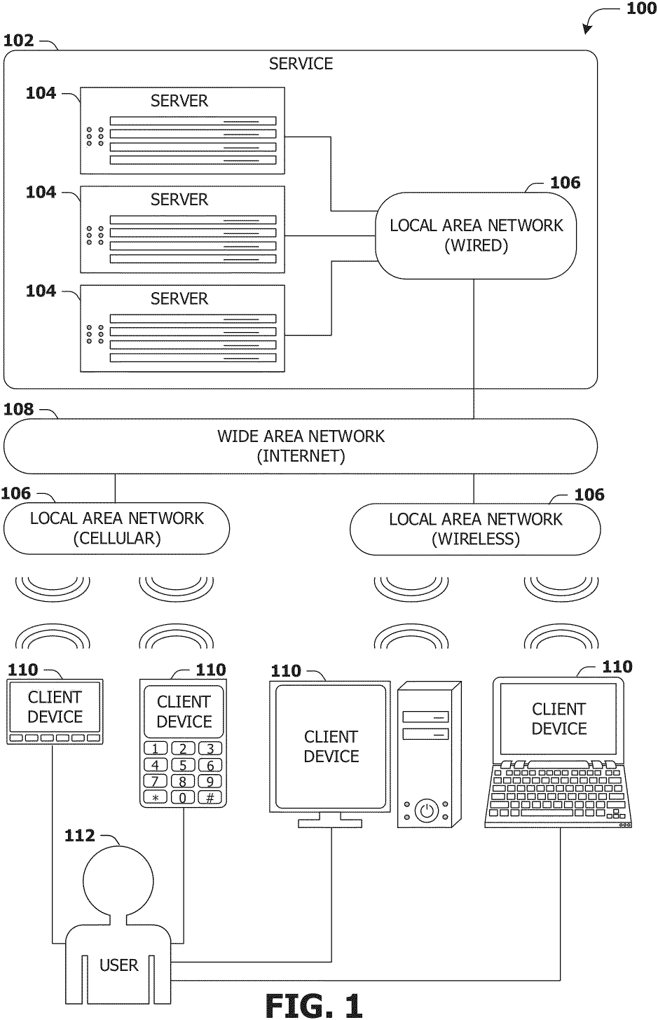

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

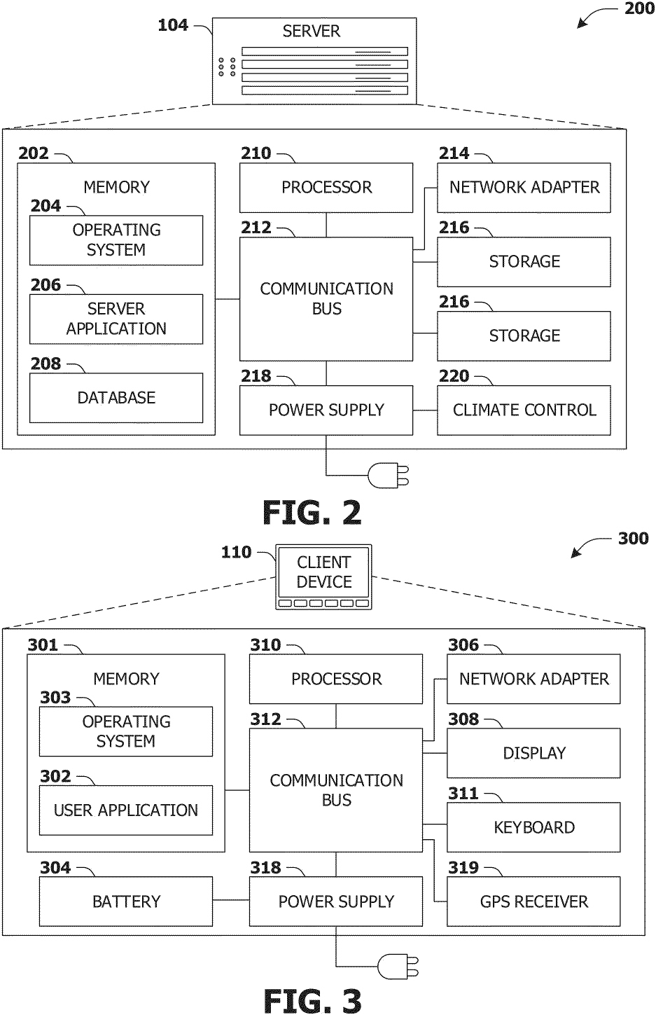

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an "all-in-one" device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an "all-in-one" device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more systems and/or techniques for clustering users into groups of users, identifying customer churn, and/or selecting content for presentation via a device based upon the groups of users and/or the identification of customer churn are provided. In some examples, content may be targeted to users of a target audience. However, it may be difficult to determine users that belong to the target audience (and/or to determine whether to present the content to the users). Thus, in accordance with one or more of the techniques presented herein, purchase data associated with users may be determined. The purchase data may be indicative of purchases by users from entities (e.g., brands, companies, retailers, stores, restaurants, etc.). The purchase data may be analyzed to determine sets of purchase metrics associated with the users. The purchase metrics may comprise recency metrics, frequency metrics and/or monetary metrics. The purchase metrics may be analyzed to determine a plurality of sets of groups of users associated with the entities. In some examples, content may be selected for presentation via a device associated with a user based upon the plurality of sets of groups of users. For example, the content may be selected based upon targeting information associated with the content and/or based upon one or more groups of users, of the plurality of sets of groups of users, to which the user belongs. Alternatively and/or additionally, the content may be selected based upon an identification of customer churn of the user from a first entity to a second entity. For example, customer churn of the user from the first entity to the second entity may be identified based upon a determination that the user is in an inactive group of users of a first set of groups of users associated with the first entity and an active group of users of a second set of groups of users associated with the second entity.

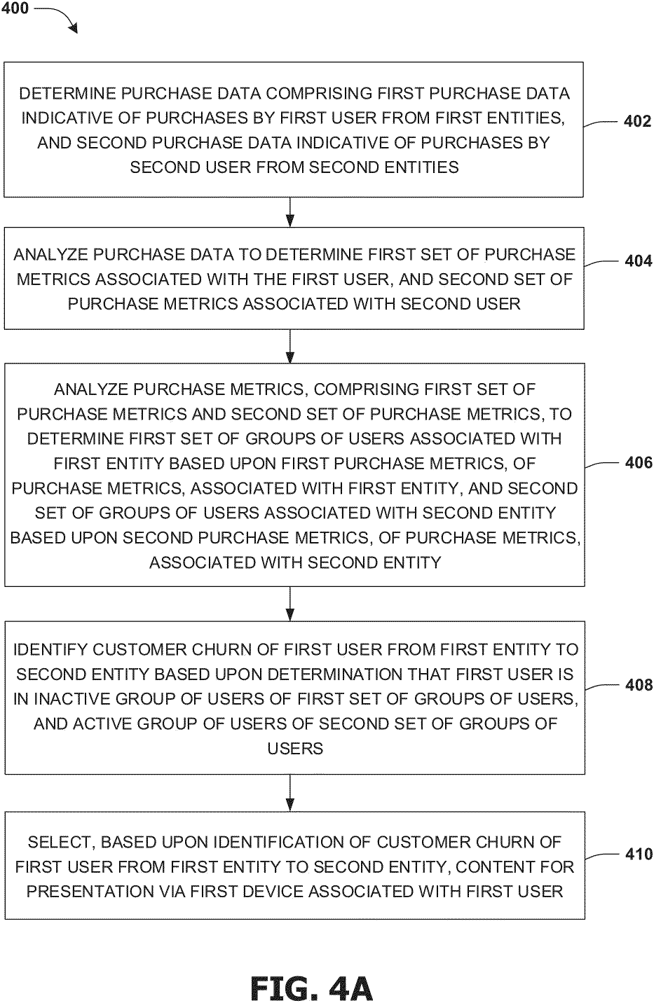

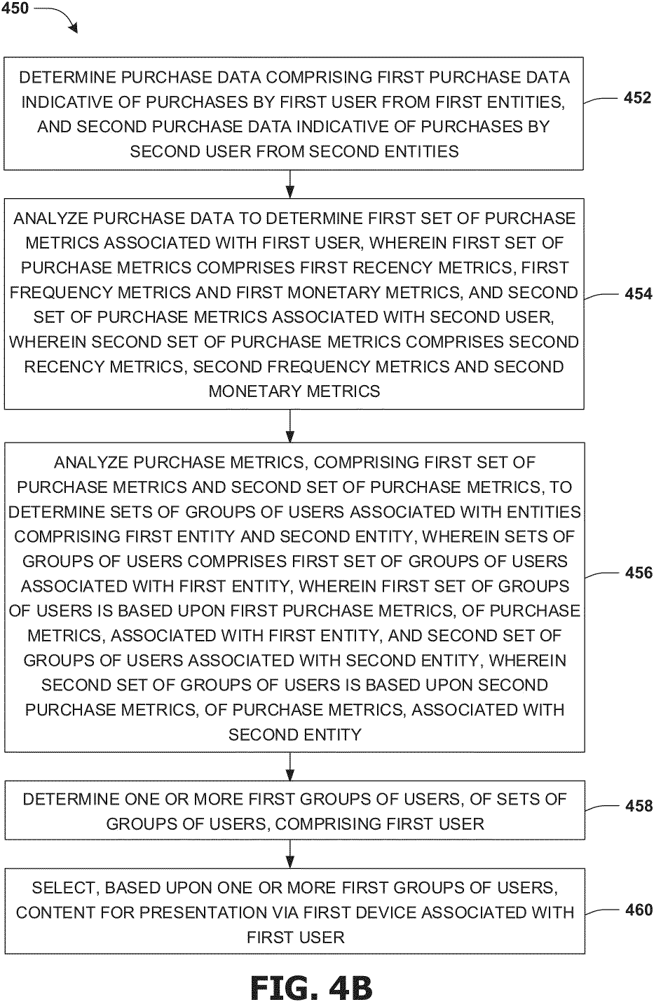

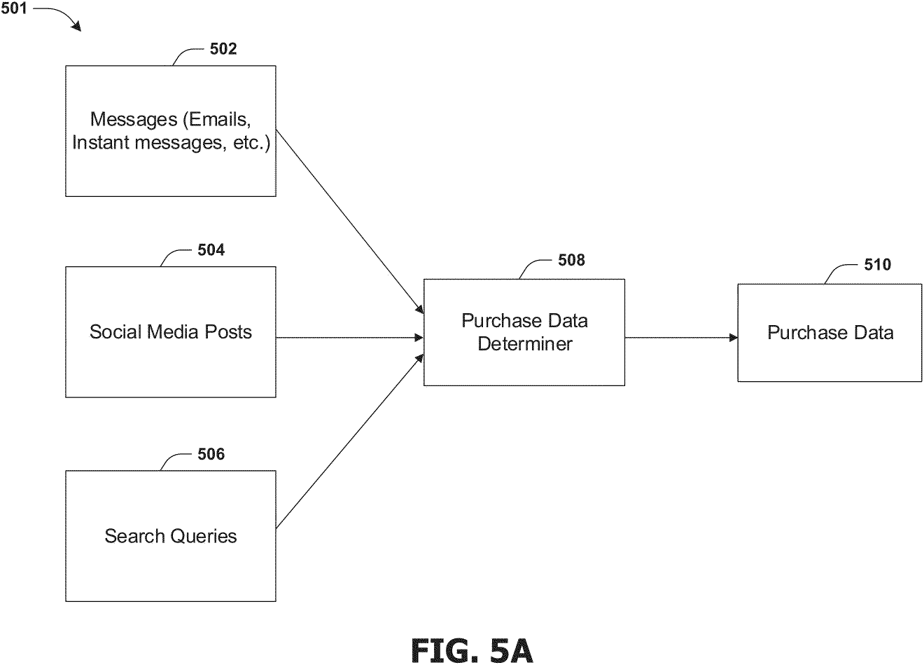

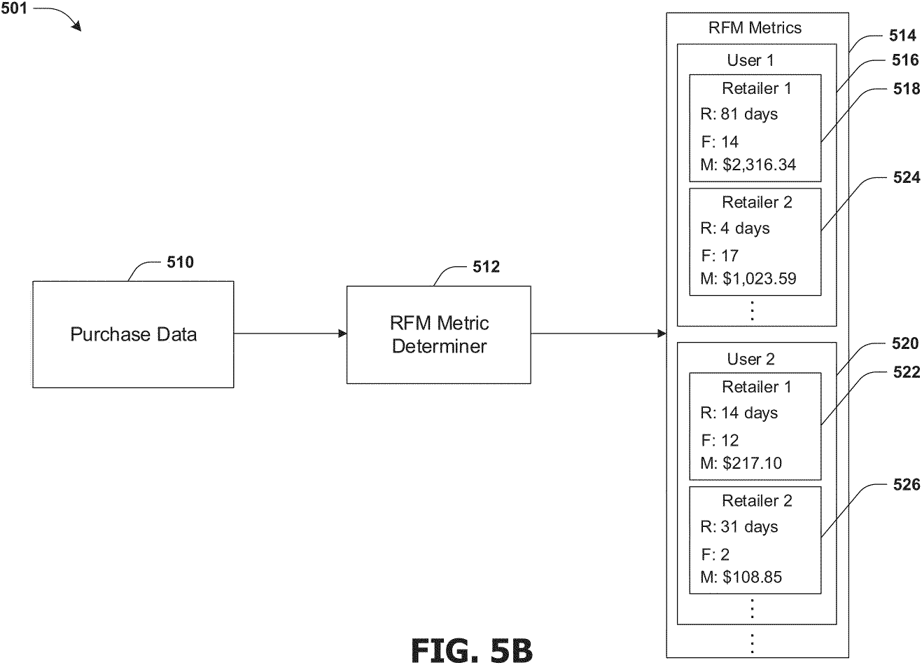

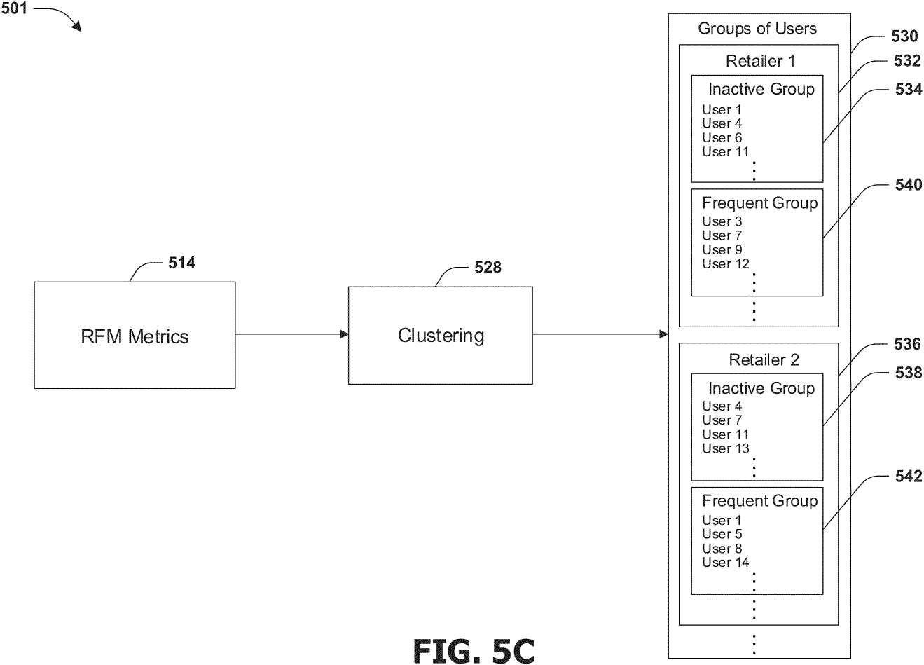

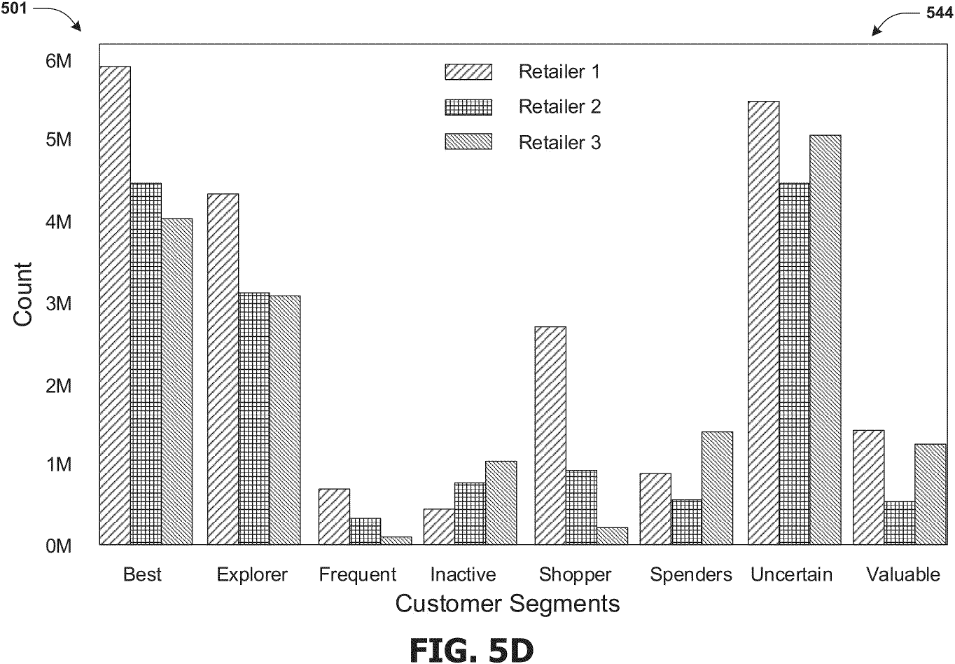

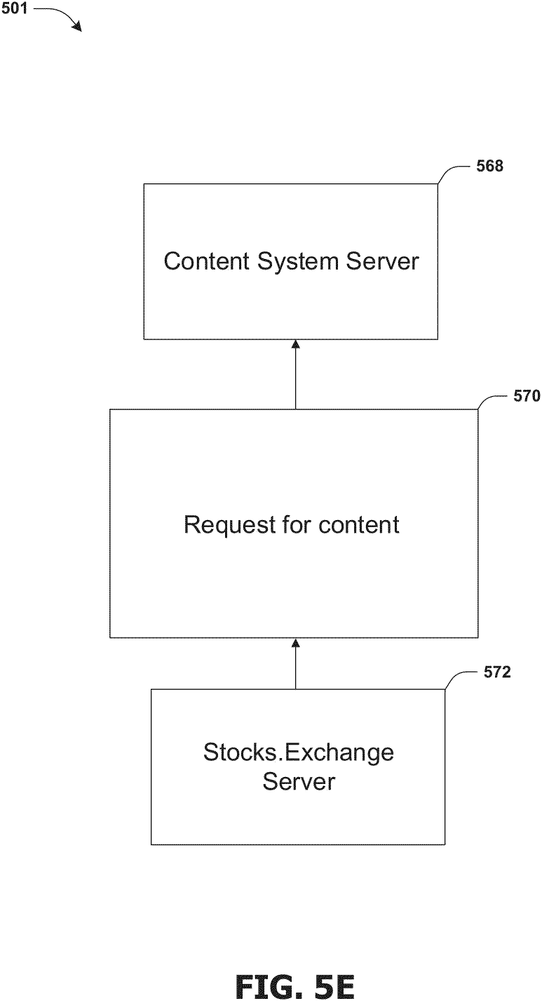

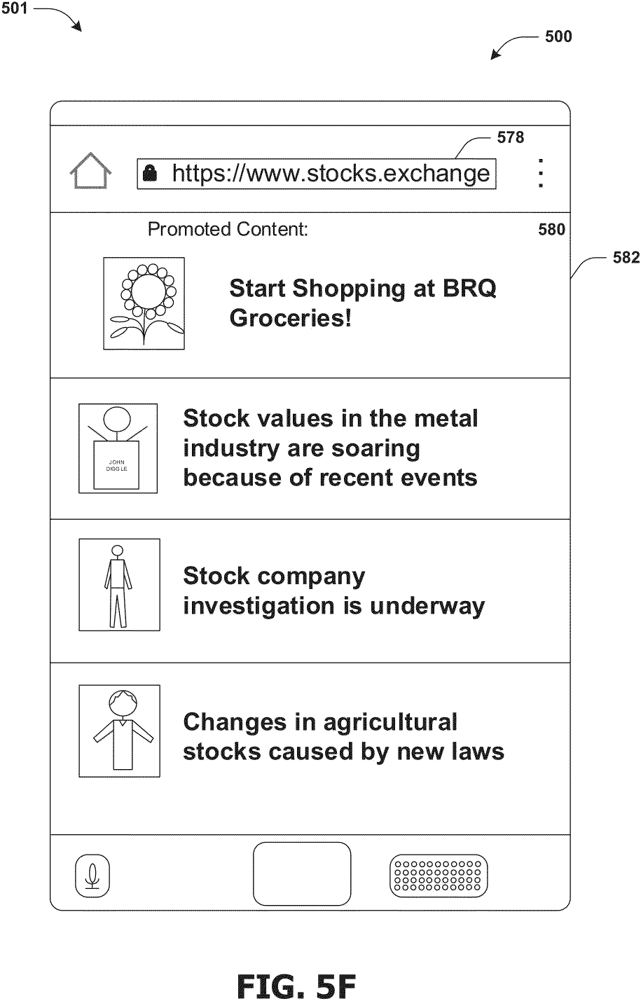

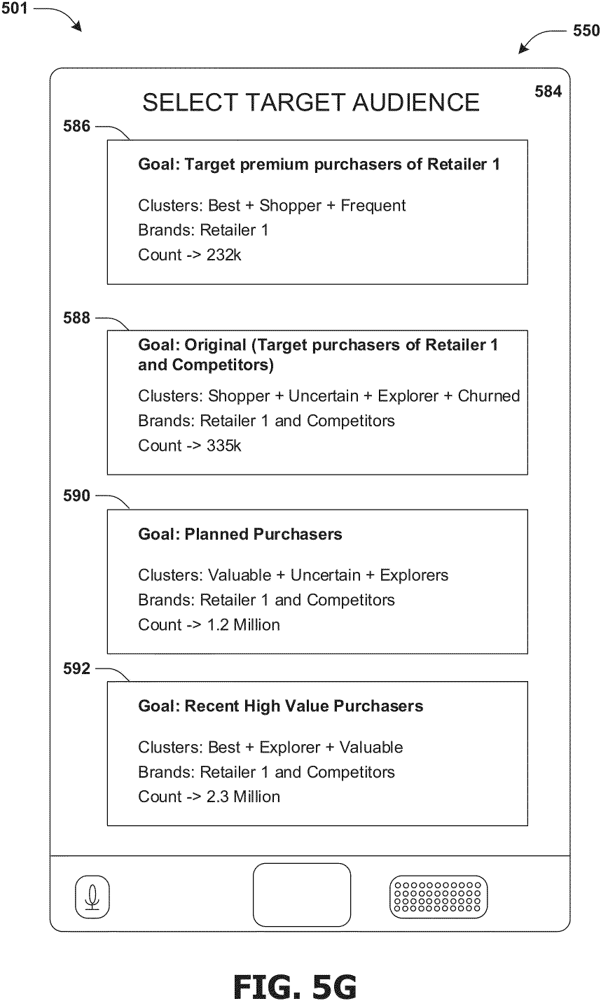

An embodiment of identifying customer churn and/or selecting content for presentation via a device based upon the identification of customer churn is illustrated by an example method 400 of FIG. 4A, and is further described in conjunction with system 501 of FIGS. 5A-5F.

At 402, purchase data may be determined. The purchase data may be indicative of purchases by users, of a plurality of users, from entities of a plurality of entities. For example, the purchase data may comprise first purchase data indicative of purchases by a first user from first entities of the plurality of entities, second purchase data indicative of purchases by a second user from second entities of the plurality of entities and/or other purchase data indicative of purchases by other users of the plurality of users from entities of the plurality of entities. In an example, the first purchase data may be indicative of at least one of purchases by the first user from the first entities, times associated with the purchases (e.g., times at which the purchases are performed), monetary amounts associated with the purchases (e.g., a monetary amount of a purchase may be an indication of an amount paid for the purchase), etc. For example, the first purchase data may comprise a purchase-time sequence of purchases by the first user from the first entities (e.g., the purchase-time sequence may be indicative of a first purchase by the first user from an entity of the first entities, a first time at which the first purchase is performed, a first monetary amount of the first purchase, a second purchase by the first user from an entity of the first entities, a second time at which the second purchase is performed, a second monetary amount of the second purchase, etc.).

FIG. 5A illustrates the purchase data (shown with reference number 510) being determined using a purchase data determiner 508. The purchase data 510 may be determined based upon messages 502, social media posts 504 and/or search queries 506. For example, the messages 502, the social media posts 504 and/or the search queries 506 may be scanned and/or analyzed by the purchase data determiner 508 to determine the purchase data 510.

In an example, messages (e.g., at least one of e-mails, instant messages, etc.) of the first user may be analyzed to identify a first message indicative of a first purchase by the first user from a first entity of the first entities. For example, the first message may comprise at least one of an invoice associated with the first purchase, an order confirmation associated with the first purchase, a reservation (e.g., a hotel reservation, a flight reservation, etc.) associated with the first purchase, etc. A monetary amount of the first purchase and/or a time of the first purchase may be determined based upon the first message (e.g., at least one of the invoice, the order confirmation, the reservation, etc. may be indicative of the monetary amount and/or the time). Alternatively and/or additionally, social media posts of the first user may be analyzed to identify a social media post indicative of the first purchase. For example, the social media post may comprise at least one of an image of a product purchased via the first purchase from the first entity, a message indicative of the first purchase and/or the first entity, etc. Alternatively and/or additionally, search queries (e.g., sets of text used to perform searches using a search engine) may be analyzed to identify one or more search queries associated with the first entity. For example, the one or more search queries may comprise one or more terms (e.g., words and/or phrases) associated with at least one of a brand corresponding to the first entity, a company corresponding to the first entity, a retailer corresponding to the first entity, a store corresponding to the first entity, a product associated with the first entity, a service associated with the first entity, etc. The first purchase may be determined based upon the one or more search queries.

In some examples, the purchase data 510 may be associated with a first period of time (e.g., a defined period of time, such as a period of 1 month, a period of 6 months, a period of 7 months or other period of time). For example, the purchase data 510 may be indicative of purchases performed during the first period of time.

At 404, the purchase data 510 may be analyzed to determine a plurality of sets of purchase metrics associated with the plurality of users. For example, the purchase data 510 may be analyzed to determine a first set of purchase metrics, of the plurality of sets of purchase metrics, associated with the first user. Alternatively and/or additionally, the purchase data 510 may be analyzed to determine a second set of purchase metrics, of the plurality of sets of purchase metrics, associated with the second user. For example, the first set of purchase metrics may be determined based upon the first purchase data associated with the first user and/or the second set of purchase metrics may be determined based upon the second purchase data associated with the second user.

In some examples, the first set of purchase metrics may comprise first metrics associated with one or more first purchases by the first user from the first entity of the first entities, second metrics associated with one or more second purchases by the first user from a second entity of the first entities, etc. Alternatively and/or additionally, the second set of purchase metrics may comprise third metrics associated with one or more third purchases by the second user from a third entity of the first entities, fourth metrics associated with one or more fourth purchases by the second user from a fourth entity of the second entities, etc.

In some examples, a set of purchase metrics of the plurality of sets of purchase metrics (and/or each set of purchase metrics of the plurality of sets of purchase metrics) may comprise one or more Recency-Frequency-Monetary (RFM) metrics (e.g., one or more recency metrics, one or more frequency metrics and/or one or more monetary metrics) associated with a user of the plurality of users.

In an example, the first set of purchase metrics may comprise RFM metrics associated with the first user and the first entities (e.g., the first metrics may comprise one or more first RFM metrics associated with the first user and the first entity, the second metrics may comprise one or more second RFM metrics associated with the first user and the second entity, etc.).

Accordingly, in some examples, the first set of purchase metrics may comprise recency metrics associated with the first user, frequency metrics associated with the first user and/or monetary metrics associated with the first user. For example, the first metrics of the first set of purchase metrics may comprise a first recency metric associated with the one or more first purchases by the first user from the first entity and/or the second metrics may comprise a second recency metric associated with the one or more second purchases by the first user from the second entity. In an example, the first recency metric may be indicative of (and/or based upon) a duration of time between a most recent purchase of the one or more first purchases and a time (e.g., a current time). For example, the first recency metric may be indicative of (and/or based upon) a time elapsed since the most recent purchase by the first user from the first entity.

Alternatively and/or additionally, the first metrics of the first set of purchase metrics may comprise a first frequency metric associated with the one or more first purchases by the first user from the first entity and/or the second metrics may comprise a second frequency metric associated with the one or more second purchases by the first user from the second entity. In an example, the first frequency metric may be indicative of (and/or based upon) a quantity of purchases by the first user from the first entity during a period of time (e.g., a defined period of time, such as a period of 10 days, a period of a month, a period of two months, or other period of time), such as the first period of time. Alternatively and/or additionally, the first frequency metric may be indicative of (and/or based upon) a rate at which purchases of the one or more first purchases are performed per unit of time (e.g., per week, per month or per other unit of time).

Alternatively and/or additionally, the first metrics of the first set of purchase metrics may comprise a first monetary metric associated with the one or more first purchases by the first user from the first entity and/or the second metrics may comprise a second monetary metric associated with the one or more second purchases by the first user from the second entity. In an example, the first monetary metric may be indicative of (and/or based upon) a monetary amount of one or more purchases by the first user from the first entity, during a period of time (e.g., a defined period of time, such as a period of 10 days, a period of a month, a period of two months, or other period of time), such as the first period of time. For example, the monetary amount may correspond to a total monetary amount (e.g., a total cost, such as a total amount paid) of the one or more first purchases by the first user from the first entity during the period of time. Alternatively and/or additionally, the monetary amount may correspond to an average monetary amount (e.g., an average cost, such as an average amount paid) of the one or more first purchases (e.g., the average monetary amount may correspond to the total monetary amount divided by a quantity of purchases of the one or more first purchases).

FIG. 5B illustrates the plurality of sets of purchase metrics (shown with reference number 514) being determined using an RFM metric determiner 512. The plurality of sets of purchase metrics 514 may comprise metrics associated with the plurality of users comprising the first user (e.g., User 1), the second user (e.g., User 2), etc. For example, the plurality of sets of purchase metrics 514 may comprise at least one of the first set of purchase metrics (shown with reference number 516) associated with the first user, the second set of purchase metrics (shown with reference number 520) associated with the second user, other sets of purchase metrics (not shown) associated with other users of the plurality of users, etc. The first set of purchase metrics 516 may comprise RFM metrics associated with purchases by the first user from entities comprising at least one of the first entity (e.g., Retailer 1), the second entity (e.g., Retailer 2), other entities (of the first entities, for example), etc. For example, the first set of purchase metrics 516 may comprise the first metrics (shown with reference number 518) associated with the first entity, the second metrics (shown with reference number 524) associated with the second entity, other metrics (not shown) associated with other entities (of the first entities, for example), etc. As shown in FIG. 5B, the first metrics 518 and/or the second metrics may comprise RFM metrics. For example, as shown in FIG. 5B, the first metrics 518 may comprise a recency metric of 81 days (e.g., a most recent purchase of the one or more first purchases by the first user from the first entity may be 81 days), a frequency metric of 14 (e.g., a quantity of purchases of the one or more first purchases by the first user from the first entity may be 14), and/or a monetary metric of $2,316.34 (e.g., a total monetary amount of the one or more first purchases may be $2,316.34). Alternatively and/or additionally, the second set of purchase metrics 520 may comprise RFM metrics associated with purchases by the second user from entities comprising at least one of the first entity (e.g., Retailer 1), the second entity (e.g., Retailer 2), one or more other entities (of the second entities, for example), etc. For example, the second set of purchase metrics 520 may comprise fifth metrics 522 associated with one or more purchases by the second user from the first entity, sixth metrics 526 associated with one or more purchases by the second user from the second entity, etc.

At 406, the plurality of sets of purchase metrics 514 (comprising the first set of purchase metrics 516 and/or the second set of purchase metrics 520) may be analyzed to determine a plurality of sets of groups of users associated with the plurality of entities. For example, a first set of groups of users associated with the first entity may be determined based upon first purchase metrics, of the plurality of sets of purchase metrics 514, associated with the first entity. For example, the first purchase metrics may comprise purchase metrics (e.g., recency metrics, frequency metrics and/or monetary metrics) associated with purchases by users (of the plurality of users, for example) from the first entity. Accordingly, the first purchase metrics may comprise the first metrics 516 of the first set of purchase metrics 516 and/or the fifth metrics 522 of the second set of purchase metrics 520. Alternatively and/or additionally, a second set of groups of users associated with the second entity may be determined based upon second purchase metrics, of the plurality of sets of purchase metrics 514, associated with the second entity. For example, the second purchase metrics may comprise purchase metrics (e.g., recency metrics, frequency metrics and/or monetary metrics) associated with purchases by users (of the plurality of users, for example) from the second entity. Accordingly, the second purchase metrics may comprise the second metrics 524 of the first set of purchase metrics 516 and/or the sixth metrics 526 of the second set of purchase metrics 520. The plurality of sets of groups of users may comprise the first set of groups of users associated with the first entity, the second set of groups of users associated with the second entity and/or other sets of groups of users associated with other entities (of the plurality of entities, for example).

FIG. 5C illustrates a clustering module 528 grouping (e.g., clustering) the plurality of users into the plurality of sets of groups of users (shown with reference number 530) associated with the plurality of entities. For example, the clustering module 528 may group the plurality of users into the plurality of sets of groups of users 530 based upon the plurality of sets of purchase metrics 514. In an example, the plurality of sets of groups 530 may comprise the first set of groups of users (shown with reference number 532) associated with the first entity (e.g., "Retailer 1"), the second set of groups of users (shown with reference number 536) associated with the second entity (e.g., "Retailer 2") and/or other sets of groups of users (not shown) associated with other entities (of the plurality of entities, for example). For example, the first set of groups of users 532 may comprise at least one of a first inactive group 534, a first frequent group 540, a first best group (not shown), a first explorer group (not shown), a first shopper group (not shown), a first spenders group (not shown), a first uncertain group (not shown), a first valuable group (not shown), etc. Alternatively and/or additionally, the second set of groups of users 536 may comprise at least one of a second inactive group 538, a second frequent group 542, a second best group (not shown), a second explorer group (not shown), a second shopper group (not shown), a second spenders group (not shown), a second uncertain group (not shown), a second valuable group (not shown), etc.

In some examples, the first set of groups of users 532 may be determined (using the clustering module 528, for example) based upon first recency metrics, first frequency metrics and/or first monetary metrics, of the first purchase metrics, associated with first users of the plurality of users. The first users of the plurality of users may be users that are determined to have performed purchases from the first entity (within the first period of time, for example). For example, the purchase data 510 may be indicative of purchases, by the first users, from the first entity.

For example, the first set of groups of users 532 may be determined by performing density-based clustering based upon the first purchase metrics (e.g., based upon the first recency metrics, the first frequency metrics and/or the first monetary metrics). For example, the clustering module 528 may perform density-based clustering to group the users into the first set of groups of users 532 based upon the first purchase metrics. For example, the density-based clustering may comprise at least one of Density-based Clustering of Applications with Noise (DBSCAN) and/or Hierarchical DBSCAN (HDBSCAN), such as scalable HDBSCAN.

Alternatively and/or additionally, the first set of groups of users 532 may be determined (using the clustering module 528, for example) based upon a first combined recency metric, a first combined frequency metric and/or a first combined frequency metric. For example, the first combined recency metric may be determined based upon the first recency metrics of the first purchase metrics (e.g., the first recency metrics may be combined, such as averaged, to determine the first combined recency metric, where the first combined recency metric may be an average of the first recency metrics). Alternatively and/or additionally, the first combined frequency metric may be determined based upon the first frequency metrics (e.g., the first frequency metrics may be combined, such as averaged, to determine the first combined frequency metric, where the first combined frequency metric may be an average of the first frequency metrics). Alternatively and/or additionally, the first combined monetary metric may be determined based upon the first monetary metrics (e.g., the first monetary metrics may be combined, such as averaged, to determine the first combined monetary metric, where the first combined monetary metric may be an average of the first monetary metrics). For example, a user may be grouped into a group of the first set of groups of users 532 based upon a determination that a recency metric of the user with respect to the first entity is higher than or lower than the first combined recency metric, that a frequency metric of the user with respect to the first entity is higher than or lower than the first combined frequency metric and/or that a monetary metric of the user with respect to the first entity is higher than or lower than the first combined monetary metric.

In an example, a user of the first users may be grouped into the first inactive group 534 based upon a determination that a recency metric of the user with respect to the first entity is higher than the first combined recency metric (or a different value), a frequency metric of the user with respect to the first entity is higher than the first combined frequency metric (or a different value) and/or a monetary metric of the user with respect to the first entity is higher than the first combined monetary metric (or a different value). For example, the first user may be grouped into the first inactive group 534 based upon a determination that the recency metric (of the first metrics 518) of the first user with respect to the first entity is higher than the first combined recency metric (or a different value), the frequency metric (of the first metrics 518) of the first user with respect to the first entity is higher than the first combined frequency metric (or a different value) and/or the monetary metric (of the first metrics 518) of the first user with respect to the first entity is higher than the first combined monetary metric (or a different value). In some examples, the first inactive group 534 may comprise users (e.g., the first user) that have performed one or more purchases from the first entity, where recency metrics associated with the users are higher than the first combined recency metric and/or a different value (e.g., durations of time elapsed since most recent purchases of the users from the first entity exceed a threshold duration of time corresponding to the first combined recency metric and/or the different value). For example, a user may be classified as an inactive customer (e.g., the user may be included in the first inactive group 534) based upon a determination that the user performed one or more purchases from the first entity, where a duration of time elapsed since a most recent purchase of the user from the first entity exceeds a threshold duration of time (e.g., a recency metric associated with the user and the first entity exceeds the first combined recency metric or a different value).

Alternatively and/or additionally, a user of the first users may be grouped into the first best group of the first set of groups of users 532 based upon a determination that a recency metric of the user with respect to the first entity is lower than the first combined recency metric (or a different value), a frequency metric of the user with respect to the first entity is higher than the first combined frequency metric (or a different value) and/or a monetary metric of the user with respect to the first entity is higher than the first combined monetary metric (or a different value). Alternatively and/or additionally, a user of the first users may be grouped into the first valuable group of the first set of groups of users 532 based upon a determination that a recency metric of the user with respect to the first entity is lower than the first combined recency metric (or a different value), a frequency metric of the user with respect to the first entity is lower than the first combined frequency metric (or a different value) and/or a monetary metric of the user with respect to the first entity is higher than the first combined monetary metric (or a different value). Alternatively and/or additionally, a user of the first users may be grouped into the first shopper group of the first set of groups of users 532 based upon a determination that a recency metric of the user with respect to the first entity is lower than the first combined recency metric (or a different value), a frequency metric of the user with respect to the first entity is higher than the first combined frequency metric (or a different value) and/or a monetary metric of the user with respect to the first entity is lower than the first combined monetary metric (or a different value). Alternatively and/or additionally, a user of the first users may be grouped into the first explorer group of the first set of groups of users 532 based upon a determination that a recency metric of the user with respect to the first entity is lower than the first combined recency metric (or a different value), a frequency metric of the user with respect to the first entity is lower than the first combined frequency metric (or a different value) and/or a monetary metric of the user with respect to the first entity is lower than the first combined monetary metric (or a different value). Alternatively and/or additionally, a user of the first users may be grouped into the first frequent group 540 of the first set of groups of users 532 based upon a determination that a recency metric of the user with respect to the first entity is higher than the first combined recency metric (or a different value), a frequency metric of the user with respect to the first entity is higher than the first combined frequency metric (or a different value) and/or a monetary metric of the user with respect to the first entity is lower than the first combined monetary metric (or a different value). Alternatively and/or additionally, a user of the first users may be grouped into the first spender group of the first set of groups of users 532 based upon a determination that a recency metric of the user with respect to the first entity is higher than the first combined recency metric (or a different value), a frequency metric of the user with respect to the first entity is lower than the first combined frequency metric (or a different value) and/or a monetary metric of the user with respect to the first entity is higher than the first combined monetary metric (or a different value). Alternatively and/or additionally, a user of the first users may be grouped into the first uncertain group of the first set of groups of users 532 based upon a determination that a recency metric of the user with respect to the first entity is higher than the first combined recency metric (or a different value), a frequency metric of the user with respect to the first entity is lower than the first combined frequency metric (or a different value) and/or a monetary metric of the user with respect to the first entity is lower than the first combined monetary metric (or a different value).

In some examples, groups of users of the first set of groups of users 532 associated with the first entity may be named in response to clustering the first users into the first set of groups of users 532. For example, names (e.g., at least one of Inactive, Frequent, Best, Explorer, Shopper, Spenders, Uncertain, Valuable, etc.) may be assigned to groups of users of the first set of groups of users 532 based upon metrics (e.g., RFM metrics) associated with users of the groups of users.

Other sets of groups of users of the plurality of sets of groups of users 530 may be determined using one or more of the techniques provided herein with respect to determining the first set of groups of users 532.

A relationship (e.g., customer relationship) between a user of the plurality of users and an entity of the plurality of entities may be classified based upon the plurality of sets of groups of users 530. In an example, a relationship (e.g., customer relationship) between the first user and the first entity may be classified as "inactive" based upon the first user being included in the first inactive group 534 of the first set of groups of users 532 associated with the first entity. Alternatively and/or additionally, a relationship (e.g., customer relationship) between the first user and the second entity may be classified as "frequent" based upon the first user being included in the second frequent group 542 of the second set of groups of users 536 associated with the second entity.

FIG. 5D illustrates a chart 544 representative of quantities of users of groups of users (e.g., customer segments) for three entities (e.g., Retailer 1, Retailer 2, and/or Retailer 3). In an example, the groups of users may comprise at least one of Best groups of users, Explorer groups of users, Frequent group of users, Inactive groups of users, Shopper groups of users, Spenders groups of users, Uncertain groups of users, Valuable groups of users, etc. In an example, Retailer 1 (e.g., the first entity), Retailer 2 (e.g., the second entity) and/or Retailer 3 (e.g., the third entity) may be associated with an entity category (e.g., the three entities may be competing entities). For example, the entity category may be indicative of at least one of a type of retailer of the first entity and/or the second entity, a type of store of the first entity and/or the second entity, a category of services provided (e.g., sold) by the first entity and/or the second entity, a category of products provided (e.g., sold) by the first entity and/or the second entity, etc. For example, the entity category may correspond to at least one of electronics equipment retailer, household product retailer, fast-food restaurant, dine-in restaurant, internet shopping platform, etc. In some examples, the chart 544 may be generated and/or displayed via a client device in response to receiving a request for the chart (e.g., the request may be indicative of at least one of the three entities, the entity category, etc.).

In some examples, such as where data (e.g., order confirmations, invoices, etc.) associated with purchases of a user from an entity is not available, a set of purchase metrics (of the plurality of sets of purchase metrics 514, for example) associated with the user may be determined (e.g., inferred) based upon user activity of the user, such as social media posts of the user, search queries of the user, internet resources accessed by the user, browsing patterns of the user, etc. Alternatively and/or additionally, one or more groups of users (of the plurality of sets of groups of users 530) to which the user belongs may be determined (e.g., inferred) based upon the user activity of the user. For example, the set of purchase metrics and/or the one or more groups of users may be determined (e.g., inferred) using one or more k-nearest neighbors techniques (e.g., running a k-nearest neighbors algorithm, such as an approximate k-nearest neighbors algorithm, based upon the user activity of the user and/or other user activity of one or more other users of the plurality of users). Distances (e.g., core distances) between the user and the one or more other users may be determined (such as based upon an output of the k-nearest neighbors algorithm). A representation (e.g., a minimum spanning tree) may be generated based upon the distances. The user (and/or the one or more other users) may be clustered based upon the representation (e.g., the user may be grouped into the one or more groups of users based upon the representation). Alternatively and/or additionally, re-clustering may be performed (e.g., noise may be clustered via the re-clustering and/or the re-clustering may be performed to filter the noise to group the user into the one or more groups of users).

At 408, customer churn of the first user from the first entity to the second entity may be identified based upon a determination that the first user is in the first inactive group 534 of the first set of groups of users 532 and in an active group of users (e.g., the second frequent group 542) of the second set of groups of users 536. For example, the first user may be classified as a churned customer based upon the identification of the customer churn of the first user from the first entity to the second entity. For example, groups of users (of the plurality of sets of groups of users 530, for example) other than inactive groups of users may be considered to be active groups of users. For example, at least one of the first frequent group 540, the first best group, the first explorer group, the first shopper group, the first spenders group, the first uncertain group, the first valuable group, the second frequent group 542, the second best group, the second explorer group, the second shopper group, the second spenders group, the second uncertain group, the second valuable group, etc. may be considered to be active groups of users (e.g., non-inactive groups of users). Alternatively and/or additionally, the customer churn of the first user may be identified based upon a determination that, previously (e.g., at a time preceding a current time by a threshold duration of time), the first user made one or more purchases from the first entity.

Alternatively and/or additionally, the customer churn of the first user may be identified based upon a determination that the first entity and the second entity are associated with the entity category (e.g., based upon a determination that the first entity and the second entity are competing entities). For example, based upon the first entity and the second entity being associated with the entity category (e.g., the same entity category), it may be determined that the first entity and the second entity are competitors. Accordingly, the customer churn of the first user may be identified based upon a determination that the first user started engaging with (e.g., purchasing products and/or services from) the second entity after becoming inactive with the first entity, where the first entity and the second entity are associated with the same entity category (e.g., the first entity and the second entity are competing entities). In an example, the entity category of the first entity and the second entity may be ride share service, where the customer churn of the first user may be identified based upon a determination (based upon the plurality of sets of groups of users 530, for example) that the first user started engaging with the second entity (e.g., ride share service B) after becoming inactive with the first entity (e.g., ride share service A), such as where the first user starts using ride share service B for ride share services after stopping using ride share service A for ride share services.

In some examples, content (e.g., at least one of articles, videos, audio files, images, webpages, advertisements, links, coupons, e-mails, messages, etc.) associated with the first entity may be targeted to churned customers associated with customer churn from the first entity (e.g., users that are determined to have started engaging with one or more competing entities after becoming inactive with the first entity). The churned customers may correspond to users, such as the first user, that are classified (based upon the plurality of sets of groups of users 530, for example) as being churned customers associated with customer churn from the first entity to one or more other entities (e.g., one or more entities associated with the entity category, such as one or more competing entities). In an example, the content may promote one or more products and/or services of the first entity and/or may be targeted to the churned customers to motivate the churned customers to re-engage with the first entity (e.g., to purchase one or more products and/or services from the first entity).

Alternatively and/or additionally, content (e.g., at least one of articles, videos, audio files, images, webpages, advertisements, links, coupons, e-mails, messages, etc.) associated with the second entity may be targeted to churned customers associated with customer churn to the second entity (e.g., users that are determined to have started engaging with the second entity after becoming inactive with one or more competing entities, such as the first entity). The churned customers may correspond to users, such as the first user, that are classified (based upon the plurality of sets of groups of users 530, for example) as being churned customers associated with customer churn from one or more entities (e.g., one or more entities associated with the entity category, such as one or more competing entities other than the second entity) to the second entity. In an example, the content may be targeted to the churned customers to motivate the churned customers to continue engaging with the second entity (e.g., to purchase one or more products and/or services from the second entity).

In some examples, a request for content associated with a first device (e.g., a phone, a laptop, a computer, a wearable device, a smart device, a television, any other type of computing device, hardware and/or software) may be received. The first device may be associated with (e.g., may belong to and/or may be used by) the first user. The request for content may correspond to a request to provide a content item (e.g., at least one of an article, a video, an audio file, an image, a webpage, an advertisement, a coupon, a link, an e-mail, a message, etc.) for presentation via the first device (e.g., to provide a content item to be presented via an internet resource, such as a web page, while the internet resource is accessed by the first device). FIG. 5E illustrates the request for content (shown with reference number 570) being received by a first server 568 associated with a content system from a second server 572 associated with the internet resource (e.g., a web page with a web address "www.stocks.exchange"). For example, the request for content 570 may be transmitted by the second server 572 in response to receiving, from the first device, a request to access the internet resource. Alternatively and/or additionally, the request for content may be transmitted to the first server 568 by the first device.

The content system may be an advertisement system (e.g., an online advertising system). Alternatively and/or additionally, the content system may not be an advertisement system. In some examples, the content system may provide content items (e.g., at least one of articles, videos, audio files, images, webpages, advertisements, links, coupons, e-mails, messages, etc.) to be presented via pages associated with the content system. For example, the pages may be associated with websites (e.g., websites providing search engines, email services, news content, communication services, etc.) associated with the content system. The content system may provide content items to be presented in (dedicated) locations throughout the pages (e.g., one or more areas of the pages configured for presentation of content items). For example, a content item may be presented at the top of a web page associated with the content system (e.g., within a banner area), at the side of the web page (e.g., within a column), in a pop-up window, overlaying content of the web page, etc. Alternatively and/or additionally, a content item may be presented within an application associated with the content system and/or within a game associated with the content system. Alternatively and/or additionally, a user may be required to consume and/or interact with the content item before the user can access content of a web page, utilize resources of an application and/or play a game.

At 410, content may be selected for presentation via the first device associated with the first user based upon the identification of the customer churn of the first user from the first entity to the second entity. For example, the content may be selected (by the content system, for example) in response to receiving the request for content 570. The content may comprise a first content item (e.g., at least one of an article, a video, an audio file, an image, a webpage, an advertisement, a link, a coupon, an e-mail, a message, etc.). In some examples, in response to the content being selected for presentation via the first device, the content may be transmitted to the first device and/or presented via the first device. FIG. 5F illustrates the first content item (shown with reference number 582) being presented via the first device (shown with reference number 500). For example, the first content item 582 may be presented via the first device 500 while the internet resource (shown with reference number 580) is displayed via the first device 500.

In an example, the first content item 582 (e.g., an advertisement) may be associated with the first entity. The first content item 582 may promote one or more products and/or services of the first entity and/or may be selected (based upon the identification of customer churn of the first user from the first entity to the second entity, for example) for presentation via the first device to motivate the first user to re-engage with the first entity (e.g., to purchase one or more products and/or services from the first entity). In an example, in response to the identification of customer churn of the first user from the first entity to the second entity, an increased amount of content items associated with the first entity (e.g., content items that promote one or more products and/or services of the first entity) may be provided to the first device 500 associated with the first user (and/or content items associated with the first entity may be provided to the first device 500 at a higher rate than prior to the identification of the customer churn of the first user from the first entity to the second entity). In an example, prior to the identification of customer churn of the first user from the first entity to the second entity, a first amount of content items associated with the first entity (e.g., content items that promote one or more products and/or services of the first entity) may be provided to the first device 500 associated with the first user. After the identification of customer churn of the first user from the first entity to the second entity, a second amount of content items associated with the first entity (e.g., content items that promote one or more products and/or services of the first entity) may be provided to the first device 500 associated with the first user based upon the identification of customer churn of the first user from the first entity to the second entity, wherein the second amount of content items may be greater than the first amount of content items.

Alternatively and/or additionally, in response to the identification of customer churn of the first user from the first entity to the second entity, a reduced amount of content items associated with the first entity (e.g., content items that promote one or more products and/or services of the first entity) may be provided to the first device 500 associated with the first user (and/or content items associated with the first entity may be not be provided and/or may stop being provided to the first device 500 in response to the identification of customer churn of the first user from the first entity to the second entity).

In an example, the first content item 582 (e.g., an advertisement) may be associated with the second entity. The first content item 582 may promote one or more products and/or services of the second entity and/or may be selected (based upon the identification of customer churn of the first user from the first entity to the second entity, for example) for presentation via the first device to motivate the first user to continue engaging with the second entity (e.g., to purchase one or more products and/or services from the second entity). In an example, in response to the identification of customer churn of the first user from the first entity to the second entity, an increased amount of content items associated with the second entity (e.g., content items that promote one or more products and/or services of the second entity) may be provided to the first device 500 associated with the first user (and/or content items associated with the second entity may be provided to the first device 500 at a higher rate than prior to the identification of the customer churn of the first user from the first entity to the second entity). In an example, prior to the identification of customer churn of the first user from the first entity to the second entity, a first amount of content items associated with the second entity (e.g., content items that promote one or more products and/or services of the second entity) may be provided to the first device 500 associated with the first user. After the identification of customer churn of the first user from the first entity to the second entity, a second amount of content items associated with the second entity (e.g., content items that promote one or more products and/or services of the second entity) may be provided to the first device 500 associated with the first user based upon the identification of customer churn of the first user from the first entity to the second entity, wherein the second amount of content items may be greater than the first amount of content items.

Alternatively and/or additionally, in response to the identification of customer churn of the first user from the first entity to the second entity, a reduced amount of content items associated with the second entity (e.g., content items that promote one or more products and/or services of the second entity) may be provided to the first device 500 associated with the first user (and/or content items associated with the second entity may be not be provided and/or may stop being provided to the first device 500 in response to the identification of customer churn of the first user from the first entity to the second entity).

Alternatively and/or additionally, in some examples, such as where purchases by users of the plurality of users from entities of the plurality of entities are contractual and/or performed periodically, metrics (of the plurality of sets of metrics 514, for example) associated with the users and/or the entities may be determined based upon periodic billings and/or payments associated with the entities. For example, sets of metrics associated with purchases by the users from the entities may be indicative of patterns for the first period of time. A pattern of the patterns may be indicative of values for time intervals within the first period of time. A value of the values may be indicative of whether or not a payment has been made by a user for one or more services by the entity within a time interval of the time intervals (and/or whether or not an invoice, a bill and/or a purchase confirmation associated with the one or more services is provided to the user by the entity). In an example, the entity may be a service provider (e.g., a telecommunication service provider, an internet service provider, a cellular service provider, etc.) and/or the user may be subscribed to a service of the entity during one or more time intervals of the time intervals of the period of time. The pattern may be indicative of a value for each time interval of the time intervals. In an example, the first period of time may be 3 months and/or the time intervals of the period of time may be a month. Thus, the pattern may be indicative of three values for the 3 months. In an example, the pattern comprising {T,T,T} (where each value is equal to "T", for example) may indicate that for each month of the 3 months, the user received an invoice, an order confirmation and/or a bill from the entity and/or the user made a payment for received services of the entity. In an example, the pattern comprising {T,F,F} (where an initial value is equal to "T" and following values are equal to "F", for example) may indicate that for an initial month of the 3 months, the user received an invoice, an order confirmation and/or a bill from the entity and/or the user made a payment for received services of the entity, and/or that for two months following the initial month, the user did not receive an invoice, an order confirmation and/or a bill from the entity and/or the user did not make a payment for received services of the entity (e.g., the user may have canceled a subscription for services provided by the entity and/or may not use services provided by the entity in the two months following the initial month). The users may be grouped (e.g., clustered) into groups of users (of the plurality of sets of groups of users 530, for example) based upon the patterns associated with the users. In an example, a user with a pattern of {T,T,T} may be grouped into a consistent group of users. Alternatively and/or additionally, a user with a pattern of {T,F,F} may be grouped into an inactive group of users. Alternatively and/or additionally, a user with a pattern of {F,F,T} and/or {F,T,T} may be grouped into a new group of users. Alternatively and/or additionally, a user with a pattern of {T,T,F} may be grouped into a may-leave group of users. Alternatively and/or additionally, a user with a pattern of {T,F,T} may be grouped into a lapsed group of users. Alternatively and/or additionally, a user with a pattern of {F,T,F} may be grouped into an irregular group of users. Alternatively and/or additionally, a user with a pattern of {F,F,F} may be grouped into a not-exist group of users. In some examples, groups of users other than inactive groups of users may be considered to be active groups of users (e.g., non-inactive groups of users). Accordingly, customer churn of a user from a fifth entity to a sixth entity may be identified based upon a determination that the user is in an inactive group of users (e.g., a user with a pattern {T,F,F}) associated with the fifth entity and in an active group of users (e.g., a group of users other than an inactive group of users) associated with the sixth entity (where the fifth entity and the sixth entity are associated with the same entity category, for example).

An embodiment of clustering users into groups of users and/or selecting content for presentation via a device based upon the groups of users is illustrated by an example method 450 of FIG. 4B, and is further described in conjunction with system 501 of FIGS. 5A-5G.

At 452, the purchase data 510 may be determined. The purchase data 510 may be indicative of purchases by users, of the plurality of users, from entities of a plurality of entities. For example, the purchase data 510 may comprise the first purchase data indicative of purchases by the first user from the first entities of the plurality of entities and/or the second purchase data indicative of purchases by the second user from the second entities of the plurality of entities. The purchase data 510 may be determined using one or more of the techniques discussed herein with respect to example method 400 and/or FIGS. 5A-5F.

At 454, the purchase data 510 may be analyzed to determine the plurality of sets of purchase metrics 514 associated with the plurality of users. For example, the purchase data 510 may be analyzed to determine the first set of purchase metrics 516 (e.g., recency metrics, frequency metrics and/or monetary metrics) associated the first user. Alternatively and/or additionally, the purchase data 510 may be analyzed to determine the second set of purchase metrics 520 (e.g., recency metrics, frequency metrics and/or monetary metrics) associated with the second user. In some examples, the plurality of sets of purchase metrics 514 (e.g., the first set of purchase metrics 516 associated with the first user, the second set of purchase metrics 520 associated with the second user and/or other sets of purchase metrics associated with other users of the plurality of users) may be determined using one or more of the techniques discussed herein with respect to example method 400 and/or FIGS. 5A-5F.

At 456, the plurality of sets of purchase metrics 514 may be analyzed to determine the plurality of sets of groups of users 530 associated with the plurality of entities. For example, the plurality of sets of groups of users 530 may comprise the first set of groups of users 532 associated with the first entity, wherein the first set of groups of users 532 is based upon the first purchase metrics, of the plurality of sets of purchase metrics 514, associated with the first entity. Alternatively and/or additionally, the plurality of sets of groups of users 530 may comprise the second set of groups of users 536 associated with the second entity, wherein the second set of groups of users 536 is based upon the second purchase metrics, of the plurality of sets of purchase metrics 514, associated with the second entity. In some examples, the plurality of sets of groups of users 530 (e.g., the first set of groups of users 532 associated with the first entity, the second set of groups of users 536 associated with the second entity and/or other sets of groups of entities associated with other entities of the plurality of entities) may be determined using one or more of the techniques discussed herein with respect to example method 400 and/or FIGS. 5A-5F.

At 458, one or more first groups of users, of the plurality of sets of groups of users 530, comprising the first user may be determined. For example, the plurality of sets of groups of users 530 may be analyzed to identify the one or more first groups of users comprising the first user (e.g., the first user may be included in each group of users of the one or more first groups of users). For example, the one or more first groups of users may be associated with one or more first entities. In an example shown in FIG. 5C, the first user (e.g., User 1) is included in the first inactive group 534 associated with the first entity and the second frequent group 542 associated with the second entity. Accordingly, the one or more first groups of users may comprise the first inactive group 534 associated with the first entity, the second frequent group 542 associated with the second entity and/or one or more other groups of users, of the plurality of sets of groups of users 530, associated with one or more other entities of the plurality of entities.

At 460, content may be selected for presentation via the first device 500 associated with the first user based upon the one or more first group of users. For example, the content may be selected (by the content system, for example) in response to receiving the request for content 570 (associated with the internet resource 580, for example). The content may comprise the first content item 582 (e.g., at least one of an article, a video, an audio file, an image, a webpage, an advertisement, a link, a coupon, an e-mail, a message, etc.). For example, the first content item 582 (e.g., an advertisement) may be associated with an entity (e.g., an entity of the plurality of entities). For example, the first content item 582 may promote one or more products and/or services of the entity. In an example, the entity associated with the content may be the first entity, the second entity, or other entity (of the plurality of entities, for example).

In some examples, the content (e.g., the first content item 582) may be selected for presentation via the first device 500 based upon targeting information associated with the content. For example, the targeting information may be indicative of one or more second groups of users (of the plurality of sets of groups of users 530, for example) to which the content is targeted. In some examples, the targeting information may be determined based upon information received from a second device associated with the entity associated with the content. For example, the information may be received via a targeting interface associated with selecting a target audience. FIG. 5G illustrates the targeting interface (shown with reference number 584) being displayed via the second device (shown with reference number 550) associated with the entity. As an example described with respect to FIG. 5G, the entity is the first entity. It may be appreciated that, in some examples, the entity for which targeting information associated with the content is determined may be an entity other than the first entity. In an example, the targeting interface 584 may be used to select a target audience to which content items (e.g., at least one of articles, videos, audio files, images, webpages, advertisements, links, coupons, e-mails, messages, etc.) associated with the first entity are targeted. In an example, the targeting interface 584 may display one or more selectable inputs associated with one or more target audiences. For example, each selectable input of the one or more selectable inputs may comprise an indication of one or more groups of users (of the plurality of sets of groups of users 530, for example) associated with a target audience and/or a count (e.g., a quantity of users included in the target audience). In an example, the one or more selectable inputs may comprise a first selectable input 586 associated with a first target audience. For example, the first target audience may correspond to users belonging to a best group of users, a shopper group of users and/or a frequent group of users. In some examples, groups of users of the first target audience may be associated with the first entity (e.g., the first target audience may correspond to users belonging to the first best group, the first shopper group and/or the first frequent group of the first set of groups of users 532, such as indicated by an indication "Brands: Retailer 1" in the first selectable input 586). Alternatively and/or additionally, the one or more selectable inputs may comprise a second selectable input 588 associated with a second target audience. For example, the second target audience may correspond to users belonging to a shopper group of users, an uncertain group of users, an explorer group of users and/or a churned group of users (e.g., the churned group of users may comprise users that are classified as churned customers of one or more entities, such as the first entity). In some examples, groups of users of the second target audience may be associated with entities of an entity category associated with the first entity (e.g., the first target audience may correspond to users belonging to shopper groups of users associated with the entities of the entity category, users belonging to uncertain groups of users associated with the entities of the entity category, users belonging to explorer groups of users of sets associated with the entities of the entity category and/or users belonging to churned groups of users associated with the entities of the entity category). Accordingly, a user may be included in the second target audience if the user is included in a shopper group of users, an uncertain group of users, an explorer group of users and/or a churned group of users associated with an entity associated with the entity category. Alternatively and/or additionally, the one or more selectable inputs may comprise a third selectable input 590 associated with a third target audience (e.g., users belonging to a valuable group of users, an uncertain group of users, and/or an explorer group of users), and/or a fourth selectable input 592 associated with a fourth target audience (e.g., users belonging to a best group of users, an explorer group of users, and/or a valuable group of users). Alternatively and/or additionally, a custom target audience may be input via the targeting interface 584. For example, one or more inputs comprising one or more indications of one or more groups of users, one or more entities associated with the groups of users and/or one or more entity categories associated with the groups of users may be received via the targeting interface 584, where the custom target audience may be determined based upon the one or more inputs.

In some examples, the targeting information (based upon which the first content item 582 is selected for presentation via the first device 500) is indicative of a target audience selected via the targeting interface 584. For example, the first content item 582 may be selected for presentation via the first device 500 based upon a determination that the first user belongs to the target audience indicated by the targeting information (such as based upon a determination that the one or more groups of users, of the one or more first groups of users to which the first user belongs, match one or more groups of users of the targeting information).

In an example, the targeting information may be indicative of a target audience comprising users belonging to frequent groups of users associated with entities associated with the entity category (e.g., grocery stores) associated with the first entity and the second entity. Accordingly, the first content item 582 may be selected for presentation via the first device 500 based upon a determination that the one or more first groups of users, to which the first user belongs, comprises a frequent group of users (of the plurality of sets of groups of users 500) associated with an entity associated with the entity category. For example, based upon the second entity being associated with the entity category, the first content item 582 may be selected for presentation via the first device 500 based upon a determination that the second frequent group 542 (of the second set of groups of users 536 associated with the second entity) comprises the first user (such as shown in FIG. 5C) and/or based upon a determination that the second frequent group 542 is part of the target audience.

In some examples, in response to the first content item 582 being selected for presentation via the first device 500, the first content item 582 may be transmitted to the first device 500 and/or presented via the first device 500. FIG. 5F illustrates the first content item 582 being presented via the first device 500. For example, the first content item 582 may be presented via the first device 500 while the internet resource 580 is displayed via the first device 500.

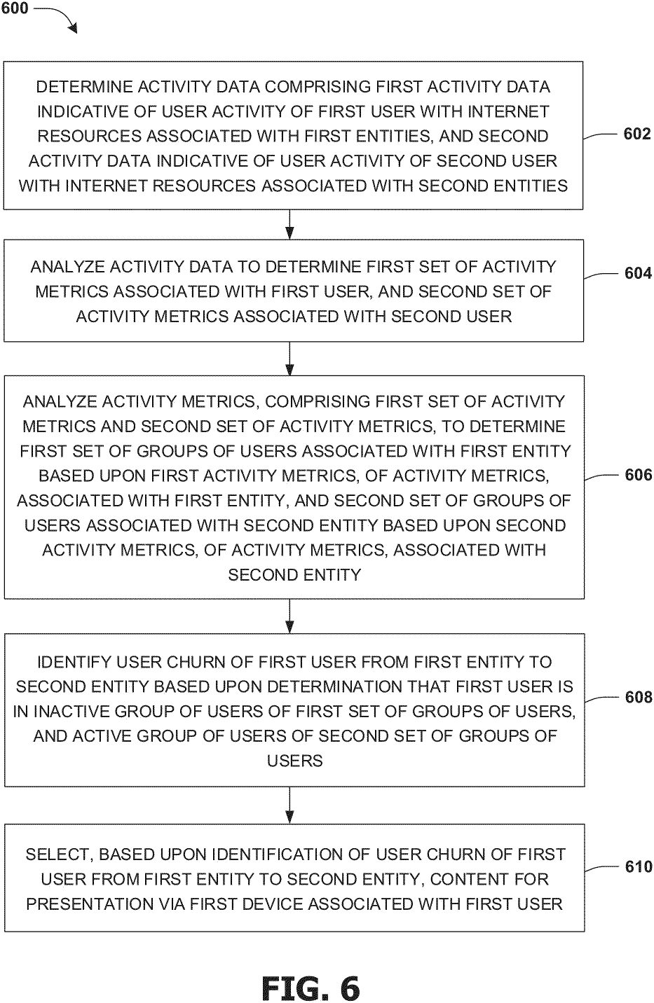

An embodiment of identifying user churn and/or selecting content for presentation via a device based upon the identification of user churn is illustrated by an example method 600 of FIG. 6. At 602, activity data may be determined. The activity data may be indicative of user activity of a plurality of users associated with entities of a plurality of entities. For example, the activity data may comprise first activity data indicative of user activity of a first user with internet resources associated with first entities. Alternatively and/or additionally, the activity data may comprise second activity data indicative of user activity of a second user with internet resources associated with second entities.

In some examples, the plurality of entities corresponds to internet resource-side (e.g., publisher-side) entities. For example, an entity of the plurality of entities may be associated with an internet resource, such as at least one of a publisher, a content platform, a content provider, a web page, a website, an application (e.g., a video streaming application (e.g., a connected TV application), a client application, a mobile application, a platform, etc.), an internet resource, an internet resource identifier associated with an internet resource, a host device associated with an internet resource (e.g., the host device may comprise one or more computing devices, storage and/or a network configured to host the internet resource), a host identifier of the host device, a domain (e.g., a domain name, a top-level domain, etc.) associated with an internet resource, an application identifier associated with an application, a publisher identifier associated with a publisher of an internet resource, etc.

In some examples, the first activity data associated with the first user may be indicative of one or more internet resources (associated with one or more entities of the first entities) accessed by one or more devices of the first user (e.g., at least one of web pages, articles, videos, audio clips, messages, emails, social media posts and/or other types of internet resources), one or more times at which the one or more internet resources are accessed, time spent accessing and/or displaying an internet resource of the one or more internet resources, etc. Alternatively and/or additionally, the second activity data associated with the second user may be indicative of one or more internet resources accessed by one or more devices of the second user.

In an example, the first entity may be a first content provider, and/or the first activity data may be indicative of the first user accessing internet resources (e.g., at least one of web pages, articles, videos, audio clips, messages, emails, social media posts and/or other types of internet resources) provided by the first content provider.

In some examples, the activity data (associated with the plurality of users and/or the plurality of entities) may be associated with a first period of time (e.g., a defined period of time, such as a period of 1 month, a period of 6 months, a period of 7 months or other period of time). For example, the activity data may be indicative of user activity performed during the first period of time (e.g., the activity data may be indicative of internet resources accessed during the first period of time).

At 604, the activity data may be analyzed to determine a plurality of sets of activity metrics associated with the plurality of users. For example, the activity data may be analyzed to determine a first set of activity metrics, of the plurality of sets of activity metrics, associated with the first user. Alternatively and/or additionally, the activity data may be analyzed to determine a second set of activity metrics, of the plurality of sets of activity metrics, associated with the second user. For example, the first set of activity metrics may be determined based upon the first activity data associated with the first user and/or the second set of activity metrics may be determined based upon the second activity data associated with the second user.

In some examples, the first set of activity metrics may comprise first metrics associated with user activity of the first user with internet resources associated with a first entity of the first entities, second metrics associated with user activity of the first user with internet resources associated with a second entity of the first entities, etc. Alternatively and/or additionally, the second set of activity metrics may comprise third metrics associated with user activity of the second user with internet resources associated with a third entity of the first entities, fourth metrics associated with user activity of the second user with internet resources associated with a fourth entity of the second entities, etc.

In some examples, a set of activity metrics of the plurality of sets of activity metrics (and/or each set of activity metrics of the plurality of sets of activity metrics) may comprise one or more Recency-Frequency-Usage (RFU) metrics (e.g., one or more recency metrics, one or more frequency metrics and/or one or more usage metrics) associated with a user of the plurality of users.

In an example, the first set of activity metrics may comprise RFU metrics associated with the first user and the first entities (e.g., the first metrics may comprise one or more first RFU metrics associated with the first user and the first entity, the second metrics may comprise one or more second RFU metrics associated with the first user and the second entity, etc.).

Accordingly, in some examples, the first set of activity metrics may comprise recency metrics associated with the first user, frequency metrics associated with the first user and/or usage metrics associated with the first user. For example, the first metrics of the first set of activity metrics may comprise a first recency metric associated with user activity of the first user with internet resources associated with the first entity and/or the second metrics may comprise a second recency metric associated with user activity of the first user with internet resources associated with the second entity. In an example, the first recency metric may be indicative of (and/or based upon) a duration of time between a most recent time at which an internet resource associated with the first entity is accessed by the first user (e.g., accessed by a device of the first user) and a time (e.g., a current time). For example, the first recency metric may be indicative of (and/or based upon) a time elapsed since the most recent time at which an internet resource associated with the first entity is accessed by the first user.

Alternatively and/or additionally, the first metrics of the first set of activity metrics may comprise a first frequency metric associated with user activity of the first user with internet resources associated with the first entity and/or the second metrics may comprise a second frequency metric associated with user activity of the first user with internet resources associated with the second entity. In an example, the first frequency metric may be indicative of (and/or based upon) a quantity of internet resources, associated with the first entity, accessed by the first user (e.g., accessed by one or more devices associated with the first user) during a period of time (e.g., a defined period of time, such as a period of 10 days, a period of a month, a period of two months, or other period of time), such as the first period of time. Alternatively and/or additionally, the first frequency metric may be indicative of (and/or based upon) a rate at which internet resources associated with the first entity are accessed per unit of time (e.g., per week, per month or per other unit of time).

Alternatively and/or additionally, the first metrics of the first set of purchase metrics may comprise a first usage metric associated with user activity of the first user with internet resources associated with the first entity and/or the second metrics may comprise a second usage metric associated with user activity of the first user with internet resources associated with the second entity. In an example, the first usage metric may be indicative of (and/or based upon) a usage amount of user activity of the first user with internet resources, associated with the first entity, during a period of time (e.g., a defined period of time, such as a period of 10 days, a period of a month, a period of two months, or other period of time), such as the first period of time. For example, the usage amount may correspond to a total usage amount (e.g., a total amount of time that internet resources associated with the first entity are accessed and/or displayed via one or more devices of the first user and/or a total amount of content, of internet resources associated with the first entity, that are accessed by one or more devices associated with the first user) of user activity of the first user with internet resources associated with the first entity during the period of time. Alternatively and/or additionally, the usage amount may correspond to an average usage amount (e.g., an average amount of time that one or more internet resources associated with the first entity are accessed and/or displayed via one or more devices of the first user per unit of time and/or an average amount content, of internet resources associated with the first entity, that are accessed by one or more devices associated with the first user per unit of time) of user activity of the first user with internet resources associated with the first entity during the period of time.

At 606, the plurality of sets of activity metrics (comprising the first set of activity metrics and/or the second set of activity metrics) may be analyzed to determine a plurality of sets of groups of users associated with the plurality of entities. For example, a first set of groups of users associated with the first entity may be determined based upon first activity metrics, of the plurality of sets of activity metrics, associated with the first entity. For example, the first activity metrics may comprise activity metrics (e.g., recency metrics, frequency metrics and/or usage metrics) associated with user activity of users (of the plurality of users, for example) with internet resources associated with the first entity. Alternatively and/or additionally, a second set of groups of users associated with the second entity may be determined based upon second activity metrics, of the plurality of sets of activity metrics, associated with the second entity. For example, the second activity metrics may comprise activity metrics (e.g., recency metrics, frequency metrics and/or usage metrics) associated with user activity of users (of the plurality of users, for example) with internet resources associated with the second entity. The plurality of sets of groups of users may comprise the first set of groups of users associated with the first entity, the second set of groups of users associated with the second entity and/or other sets of groups of users associated with other entities (of the plurality of entities, for example). In some examples, the plurality of sets of groups of users (e.g., the first set of groups of users associated with the first entity, the second set of groups of users associated with the second entity and/or other sets of groups of entities associated with other entities of the plurality of entities) may be determined using one or more of the techniques discussed herein with respect to example method 400 and/or FIGS. 5A-5F (where monetary metrics discussed with respect to example method 400 and/or FIGS. 5A-5F may be replaced with usage metrics, for example), such as using one or more of the techniques discussed herein with respect to determining the plurality of sets of groups of users 530. For example, the plurality of users may be grouped (e.g., clustered, such as using density-based clustering, DBSCAN, HDBSCAN such as scalable HDBSCAN, etc.) into the plurality of sets of groups of users (using the clustering module 528, for example) based upon the plurality of sets of activity metrics.

At 608, user churn of the first user from the first entity to the second entity may be identified based upon a determination that the first user is in an inactive group of the first set of groups of users associated with the first entity and in an active group of users of the second set of groups of users associated with the second entity. For example, the first user may be classified as a churned user based upon the identification of the user churn of the first user from the first entity to the second entity. For example, groups of users (of the plurality of sets of groups of users, for example) other than inactive groups of users may be considered to be active groups of users. Alternatively and/or additionally, the user churn of the first user may be identified based upon a determination that, previously (e.g., at a time preceding a current time by a threshold duration of time), the first user accessed one or more internet resources associated with the first entity.

Alternatively and/or additionally, the user churn of the first user may be identified based upon a determination that the first entity and the second entity are associated with the entity category (e.g., based upon a determination that the first entity and the second entity are competing entities). For example, based upon the first entity and the second entity being associated with the entity category (e.g., the same entity category), it may be determined that the first entity and the second entity are competitors. Accordingly, the user churn of the first user may be identified based upon a determination that the first user started engaging with (e.g., consuming content associated with) the second entity after becoming inactive with the first entity, where the first entity and the second entity are associated with the same entity category (e.g., the first entity and the second entity are competing entities). In an example, the entity category of the first entity and the second entity may be at least one of a news article platform, a video platform, a news publisher, other type of content platform, etc. In an example in which the entity category of the first entity and the second entity is news article platform, the user churn of the first user may be identified based upon a determination (based upon the plurality of sets of groups of users, for example) that the first user started engaging with the second entity (e.g., news article platform B) after becoming inactive with the first entity (e.g., news article platform A), such as where the first user starts accessing and/or interacting with internet resources (e.g., news articles) via news article platform B after stopping accessing and/or interacting with internet resources (e.g., news articles) via news article platform A.

In some examples, content (e.g., at least one of articles, videos, audio files, images, webpages, advertisements, links, coupons, e-mails, messages, etc.) associated with the first entity may be targeted to churned users associated with user churn from the first entity (e.g., users that are determined to have started engaging with the one or more competing entities after becoming inactive with the first entity). The churned users may correspond to users, such as the first user, that are classified (based upon the plurality of sets of groups of users 530, for example) as being churned users associated with user churn from the first entity to one or more other entities (e.g., one or more entities associated with the entity category, such as one or more competing entities). In an example, the content may be targeted to the churned users to motivate the churned users to re-engage with the first entity (e.g., to access and/or utilize internet resources associated with the first entity).

Alternatively and/or additionally, content (e.g., at least one of articles, videos, audio files, images, webpages, advertisements, links, coupons, e-mails, messages, etc.) associated with the second entity may be targeted to churned users associated with user churn to the second entity (e.g., users that are determined to have started engaging with the second entity after becoming inactive with one or more competing entities, such as the first entity). The churned users may correspond to users, such as the first user, that are classified (based upon the plurality of sets of groups of users 530, for example) as being churned users associated with user churn from one or more entities (e.g., one or more entities associated with the entity category, such as one or more competing entities other than the second entity) to the second entity. In an example, the content may be targeted to the churned users to motivate the churned users to continue engaging with the second entity (e.g., to access and/or utilize internet resources associated with the first entity).

At 610, content may be selected for presentation via a first device associated with the first user based upon the identification of the user churn of the first user from the first entity to the second entity. For example, the content may be selected (by the content system, for example) in response to receiving a request for content. The content may comprise a first content item (e.g., at least one of an article, a video, an audio file, an image, a webpage, an advertisement, a link, a coupon, an e-mail, a message, etc.). In some examples, in response to the content being selected for presentation via the first device, the content may be transmitted to the first device and/or presented via the first device. The content (e.g., the first content item) may be selected and/or presented via the first device using one or more of the techniques discussed herein with respect to example method 400 and/or FIGS. 5A-5F.

In an example, the first content item (e.g., an advertisement) may be associated with the first entity. The first content item may promote one or more internet resources and/or services of the first entity and/or may be selected (based upon the identification of user churn of the first user from the first entity to the second entity, for example) for presentation via the first device 500 to motivate the first user to re-engage with the first entity (e.g., to access and/or utilize internet resources associated with the first entity). In an example, in response to the identification of user churn of the first user from the first entity to the second entity, an increased amount of content items associated with the first entity (e.g., content items that promote one or more internet resources and/or services of the first entity) may be provided to the first device 500 associated with the first user (and/or content items associated with the first entity may be provided to the first device 500 at a higher rate than prior to the identification of the user churn of the first user from the first entity to the second entity). In an example, prior to the identification of user churn of the first user from the first entity to the second entity, a first amount of content items associated with the first entity (e.g., content items that promote one or more internet resources and/or services of the first entity) may be provided to the first device 500 associated with the first user. After the identification of user churn of the first user from the first entity to the second entity, a second amount of content items associated with the first entity (e.g., content items that promote one or more internet resources and/or services of the first entity) may be provided to the first device 500 associated with the first user based upon the identification of user churn of the first user from the first entity to the second entity, wherein the second amount of content items may be greater than the first amount of content items.

Alternatively and/or additionally, in response to the identification of user churn of the first user from the first entity to the second entity, a reduced amount of content items associated with the first entity (e.g., content items that promote one or more internet resources and/or services of the first entity) may be provided to the first device 500 associated with the first user (and/or content items associated with the first entity may be not be provided and/or may stop being provided to the first device 500 in response to the identification of user churn of the first user from the first entity to the second entity).

In an example, the first content item (e.g., an advertisement) may be associated with the second entity. The first content item may promote one or more internet resources and/or services of the second entity and/or may be selected (based upon the identification of user churn of the first user from the first entity to the second entity, for example) for presentation via the first device 500 to motivate the first user to continue engaging with the second entity (e.g., to access and/or utilize internet resources associated with the second entity). In an example, in response to the identification of user churn of the first user from the first entity to the second entity, an increased amount of content items associated with the second entity (e.g., content items that promote one or more internet resources and/or services of the second entity) may be provided to the first device 500 associated with the first user (and/or content items associated with the second entity may be provided to the first device 500 at a higher rate than prior to the identification of the user churn of the first user from the first entity to the second entity). In an example, prior to the identification of user churn of the first user from the first entity to the second entity, a first amount of content items associated with the second entity (e.g., content items that promote one or more internet resources and/or services of the second entity) may be provided to the first device 500 associated with the first user. After the identification of user churn of the first user from the first entity to the second entity, a second amount of content items associated with the second entity (e.g., content items that promote one or more internet resources and/or services of the second entity) may be provided to the first device 500 associated with the first user based upon the identification of user churn of the first user from the first entity to the second entity, wherein the second amount of content items may be greater than the first amount of content items.

Alternatively and/or additionally, in response to the identification of user churn of the first user from the first entity to the second entity, a reduced amount of content items associated with the second entity (e.g., content items that promote one or more internet resources and/or services of the second entity) may be provided to the first device 500 associated with the first user (and/or content items associated with the second entity may be not be provided and/or may stop being provided to the first device 500 in response to the identification of user churn of the first user from the first entity to the second entity).

Alternatively and/or additionally, in some examples, the content may be selected for presentation via the first device based upon targeting information associated with the content (e.g., targeting information provided by an entity) and/or based upon one or more first groups, of the plurality of sets of groups, comprising the first user. For example, the content may be selected for presentation via the first device based upon a determination that one or more groups of users, of the one or more first groups of users to which the first user belongs, match one or more groups of users of the targeting information. In some examples, the content (e.g., the first content item) may be selected and/or presented via the first device and/or the targeting information may be determined using one or more of the techniques discussed herein with respect to example method 450 and/or FIGS. 5A-5G.

Implementation of at least some of the disclosed subject matter may lead to benefits including, but not limited to, more accurate and/or appropriate selection of a content item for presentation via a client device that has a higher probability of resulting in the content item being selected and/or a higher probability of a user consuming the content item to have an interest in the content item (e.g., as a result of determining groups of users based upon determined metrics, such as recency metrics, frequency metrics and/or monetary metrics, as a result of identifying churned customers based upon the groups of users, as a result of selecting the content item for presentation via the client device based upon identification of customer churn and/or based upon the groups of users and/or targeting information received via a targeting interface, etc.).

Alternatively and/or additionally, implementation of at least some of the disclosed subject matter may lead to benefits including a reduction in screen space and/or an improved usability of a display (e.g., of the client device) (e.g., as a result of the higher probability of the user consuming the content item to have an interest in the content item, wherein the user may not view content that the user does not have an interest in, wherein the user may not need to open a separate application and/or a separate window in order to find content having the subject matter that the user has an interest in, etc.).

Alternatively and/or additionally, implementation of at least some of the disclosed subject matter may lead to benefits including an increase in generalized revenue for presenting content items via client devices (e.g., as a result of the higher probability of the content item being selected and/or the higher probability of the user consuming the content item to have an interest in the content item, thereby increasing a probability that the user performs a conversion event associated with the content item, such as purchases a product and/or service from an entity associated with the content item, etc.).

Alternatively and/or additionally, implementation of at least some of the disclosed subject matter may lead to benefits including a reduction in bandwidth (e.g., as a result of reducing a need for the user to open a separate application and/or a separate window in order to search throughout the internet and/or navigate through internet content to find content that the user has an interest in).

Alternatively and/or additionally, implementation of at least some of the disclosed subject matter may lead to benefits including a reduction in screen space and/or an improved usability of a display (e.g., of a client device). In some examples, the reduction in screen space and/or the improved usability of the display (e.g., of the client device) may be a result of determining groups of users and/or displaying an improved interface (e.g., a targeting interface) with which a user (associated with an entity, for example) can select a target audience comprising one or more desired groups of users of the determined groups of users without requiring a separate window to be opened.

In some examples, at least some of the disclosed subject matter may be implemented on a client device, and in some examples, at least some of the disclosed subject matter may be implemented on a server (e.g., hosting a service accessible via a network, such as the Internet).

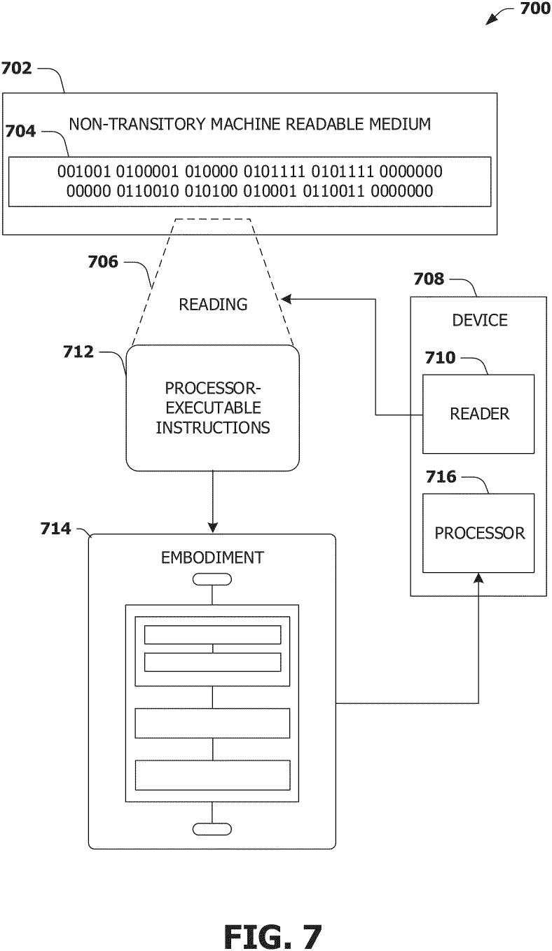

FIG. 7 is an illustration of a scenario 700 involving an example non-transitory machine readable medium 702. The non-transitory machine readable medium 702 may comprise processor-executable instructions 712 that when executed by a processor 716 cause performance (e.g., by the processor 716) of at least some of the provisions herein (e.g., embodiment 714). The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 702 stores computer-readable data 704 that, when subjected to reading 706 by a reader 710 of a device 708 (e.g., a read head of a hard disk drive, or a read operation invoked on a solid-state storage device), express the processor-executable instructions 712. In some embodiments, the processor-executable instructions 712, when executed, cause performance of operations, such as at least some of the example method 400 of FIG. 4A, example method 450 of FIG. 4B and/or example method 600 of FIG. 6, for example. In some embodiments, the processor-executable instructions 712 are configured to cause implementation of a system, such as at least some of the exemplary system 501 of FIGS. 5A-5G, for example.

### 3. Usage of Terms

As used in this application, "component," "module," "system", "interface", and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, "first," "second," and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, "example" is used herein to mean serving as an instance, illustration, etc., and not necessarily as advantageous. As used herein, "or" is intended to mean an inclusive "or" rather than an exclusive "or". In addition, "a" and "an" as used in this application are generally be construed to mean "one or more" unless specified otherwise or clear from context to be directed to a singular form. Also, at least one of A and B and/or the like generally means A or B or both A and B. Furthermore, to the extent that "includes", "having", "has", "with", and/or variants thereof are used in either the detailed description or the claims, such terms are intended to be inclusive in a manner similar to the term "comprising".

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term "article of manufacture" as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
determining purchase data comprising:
first purchase data indicative of purchases by a first user from first entities; and
second purchase data indicative of purchases by a second user from second entities;
analyzing the purchase data to determine:
a first set of purchase metrics associated with the first user; and
a second set of purchase metrics associated with the second user;
analyzing purchase metrics, comprising the first set of purchase metrics and the second set of purchase metrics, to determine:
a first set of groups of users associated with a first entity based upon first purchase metrics, of the purchase metrics, associated with the first entity; and
a second set of groups of users associated with a second entity based upon second purchase metrics, of the purchase metrics, associated with the second entity;
identifying customer churn of the first user from the first entity to the second entity based upon a determination that the first user is in:
an inactive group of users of the first set of groups of users; and
an active group of users of the second set of groups of users; and
selecting, based upon the identification of the customer churn of the first user from the first entity to the second entity, content for presentation via a first device associated with the first user.

2. The method of claim 1, wherein:
the first set of purchase metrics comprises recency metrics comprising:
a first recency metric associated with one or more first purchases, by the first user, from a third entity of the first entities; and
a second recency metric associated with one or more second purchases, by the first user, from a fourth entity of the first entities.

3. The method of claim 1, wherein:
the first set of purchase metrics comprises frequency metrics comprising:
a first frequency metric associated with one or more first purchases, by the first user, from a third entity of the first entities; and
a second frequency metric associated with one or more second purchases, by the first user, from a fourth entity of the first entities.

4. The method of claim 1, wherein:
the first set of purchase metrics comprises monetary metrics comprising:
a first monetary metric associated with one or more first purchases, by the first user, from a third entity of the first entities; and
a second monetary metric associated with one or more second purchases, by the first user, from a fourth entity of the first entities.

5. The method of claim 1, wherein the determining the purchase data comprises:
analyzing messages associated with the first user to identify a first message indicative of a first purchase by the first user from a third entity of the first entities.

6. The method of claim 1, wherein:
the identification of the customer churn of the first user from the first entity to the second entity is based upon a determination that the first entity and the second entity are associated with an entity category.

7. The method of claim 1, wherein the determining the first set of groups of users comprises:
clustering users into the first set of groups of users based upon the first purchase metrics associated with the first entity.

8. The method of claim 7, wherein:
the clustering comprises performing density-based clustering.

9. The method of claim 1, comprising:
receiving a request for content associated with the first device, wherein the selecting the content for presentation via the first device is performed in response to receiving the request for content; and
transmitting the content to the first device.

10. The method of claim 1, wherein the first set of purchase metrics comprises:
recency metrics comprising:
a first recency metric associated with one or more first purchases, by the first user, from a third entity of the first entities; and
a second recency metric associated with one or more second purchases, by the first user, from a fourth entity of the first entities;
frequency metrics comprising:
a first frequency metric associated with the one or more first purchases, by the first user, from the third entity; and
a second frequency metric associated with the one or more second purchases, by the first user, from the fourth entity; and
monetary metrics comprising:
a first monetary metric associated with the one or more first purchases, by the first user, from the third entity of the first entities; and
a second monetary metric associated with the one or more second purchases, by the first user, from the fourth entity of the first entities.

11. A computing device comprising:
a processor; and
memory comprising processor-executable instructions that when executed by the processor cause performance of operations, the operations comprising:
determining purchase data comprising:
first purchase data indicative of purchases by a first user from first entities; and
second purchase data indicative of purchases by a second user from second entities;
analyzing the purchase data to determine:
a first set of purchase metrics associated with the first user, wherein the first set of purchase metrics comprises first recency metrics, first frequency metrics and first monetary metrics; and
a second set of purchase metrics associated with the second user, wherein the second set of purchase metrics comprises second recency metrics, second frequency metrics and second monetary metrics;
analyzing purchase metrics, comprising the first set of purchase metrics and the second set of purchase metrics, to determine sets of groups of users associated with entities comprising a first entity and a second entity, wherein the sets of groups of users comprises:
a first set of groups of users associated with the first entity, wherein the first set of groups of users is based upon first purchase metrics, of the purchase metrics, associated with the first entity; and
a second set of groups of users associated with the second entity, wherein the second set of groups of users is based upon second purchase metrics, of the purchase metrics, associated with the second entity;
determining one or more first groups of users, of the sets of groups of users, comprising the first user; and
selecting, based upon the one or more first groups of users, content for presentation via a first device associated with the first user.

12. The computing device of claim 11, the operations comprising:
receiving, from a second device, targeting information associated with the content, wherein:
the targeting information is indicative of one or more second groups of users to which the content is targeted; and
the selection of the content for presentation via the first device is based upon a determination that one or more groups of users, of the one or more first groups of users, are comprised in the one or more second groups of users indicated by the targeting information.

13. The computing device of claim 11, wherein the determining the first set of groups of users comprises:
clustering users into the first set of groups of users based upon the first purchase metrics associated with the first entity.

14. The computing device of claim 13, wherein:
the clustering comprises performing density-based clustering.

15. The computing device of claim 11, the operations comprising:
receiving a request for content associated with the first device, wherein the selecting the content for presentation via the first device is performed in response to receiving the request for content; and
transmitting the content to the first device.

16. A non-transitory machine readable medium having stored thereon processor-executable instructions that when executed cause performance of operations, the operations comprising:
determining activity data comprising:
first activity data indicative of user activity of a first user with internet resources associated with first entities; and
second activity data indicative of user activity of a second user with internet resources associated with second entities;
analyzing the activity data to determine:
a first set of activity metrics associated with the first user; and
a second set of activity metrics associated with the second user;
analyzing activity metrics, comprising the first set of activity metrics and the second set of activity metrics, to determine:
a first set of groups of users associated with a first entity based upon first activity metrics, of the activity metrics, associated with the first entity; and
a second set of groups of users associated with a second entity based upon second activity metrics, of the activity metrics, associated with the second entity;
identifying user churn of the first user from the first entity to the second entity based upon a determination that the first user is in:
an inactive group of users of the first set of groups of users; and
an active group of users of the second set of groups of users; and
selecting, based upon the identification of the user churn of the first user from the first entity to the second entity, content for presentation via a first device associated with the first user.

17. The non-transitory machine readable medium of claim 16, wherein:
the first set of activity metrics comprises recency metrics comprising:
a first recency metric associated with user activity of the first user with one or more first internet resources associated with a third entity of the first entities; and
a second recency metric associated with user activity of the first user with one or more second internet resources associated with a fourth entity of the first entities.

18. The non-transitory machine readable medium of claim 16, wherein:
the first set of activity metrics comprises frequency metrics comprising:
a first frequency metric associated with user activity of the first user with one or more first internet resources associated with a third entity of the first entities; and
a second recency metric associated with user activity of the first user with one or more second internet resources associated with a fourth entity of the first entities.

19. The non-transitory machine readable medium of claim 16, wherein the determining the first set of groups of users comprises:
clustering users into the first set of groups of users based upon the first activity metrics associated with the first entity.

20. The non-transitory machine readable medium of claim 19, wherein:
the clustering comprises performing density-based clustering.
